(19) United States
(12) Patent Application Publication
(10) Pub. No.: US 2004/0037031 A1
(43) Pub. Date: Feb. 26, 2004

(54) Notebook computer plug-in recess structure

(75) Inventor: Cheng-Hsiung Yen, Luchou City (TW)

Correspondence Address: BACON & THOMAS, PLLC, 625 SLATERS LANE, FOURTH FLOOR, ALEXANDRIA, VA, 22314

(73) Assignee: Inventec Corporation, Taipei (TW)

(21) Appl. No.: 10/226,143

(22) Filed: Aug. 23, 2002

(51) Int. Cl. G06F 1/16

(52) U.S. Cl. 361/683

(57) ABSTRACT

The invention is to provide a notebook computer plug-in recess structure, which consists a mainboard installed within a main system case of a notebook computer, a control panel disposed on said main system case adjacent to one surface of a screen thereof, a minimum of one plug-in recess situated in said control panel, and a minimum of one connector positioned within the interior section of each said plug-in recess, wherein each said connector is circuited to said mainboard such that one expansion module is brought into continuity with said mainboard via each said connector for transferring data from each said expansion module to said mainboard for the subsequent execution of processing or receiving commands forwarded by said mainboard.

### BACKGROUND OF THE INVENTION

1) Field of the Invention

The invention herein relates to a notebook computer plug-in recess structure.

2) Description of the Prior Art

The contemporary world is in an age of rich information growth, with the rapid development of computer-generated information products resulting in virtually unlimited benefits to everyone that are inseparable from our lives, enabling the world in which we live to enter a technological age of prolific information development. With the continuous release of new information products today, especially the widespread utilization of notebook computers, it is not difficult for us to know that future notebook computers capable of providing more convenience and more effective total service has by necessity become a major indicator in the evaluation of the information product manufacturing technology of various nations that will determine which country is in the lead.

Since early generation portable computers were not lightweight and weighed approximately seven to fourteen kilograms, people felt them to be cumbrous when carried about. Currently available notebook computers now weigh only one to four kilograms, but their research and development in has in addition to a continuous focus on lighter, thinner, shorter, and more compact designs also included a constant emphasis on all-in-one designs. As a result, notebook computers soon became one of the most highly selling information products in the information market. Resembling a notebook in that can be opened or closed and, furthermore, having a unique form factor that allows it to be easily taken afield and operated, a conventional notebook computer consists of a screen and a main system case as well as a minimum of one hinge component conjoining them, wherein a control panel is disposed on the said main system case adjacent to one surface of the said screen and a keyboard module is inset in the surface of the said control panel and, furthermore, a pointing device such as a touch stick, a touch pad, or a track ball is typically situated in the said control panel.

Due the prolific development of multimedia technology, currently available computers equipped with multimedia capability reflect this development theme. In other words, all computers have gradually developed into multimedia computers, which raises the question: What are multimedia computers? The term refers to computers capable of processing audio, moving images, still pictures, graphics, animated drawings, and other multimedia information and even having optional control over video devices and musical instrument digital interface (MIDI). As a result, since conventional input devices can no longer be utilized for the latest multimedia applications, multimedia information input devices such as multimedia keyboards were introduced. Furthermore, provision was made inside the main system cases of conventional personal computers for the placement of enough expansion slots to support the insertion of various multimedia interface cards. However, since ease of portability is an emphasized feature of conventional notebook computers, their main system cases are typically not very large. In other words, the interface card expansion capacity of a conventional notebook computer is rather low, resulting in considerable conflict and limitations with respect to multimedia applications.

Looking at the notebook computers currently available on the information market and the countless brands, we are easily aware of the fierce degree of sales competition in the information market and, needless to say, while this places each computer company under enormous pressure to achieve marketing gains, the same situation has also increases consumer selection opportunities. Therefore, when most consumers purchase notebook computers, the majority are guided by basic principle to expect a reasonably price unit having multimedia capability and, furthermore, an ergonomically designed, all-in-one notebook computer. As a result, in addition to reasonable prices, the capability to optimize multimedia capability and ergonomic design will be another factor that determines competitiveness among computer companies in the information market.

In the prevailing information market, most notebook computers have multimedia capability, but with the extremely rapid development of multimedia information marked by the continuous release of a wide range of multimedia software and hardware, conventional input devices (such as keyboards) are incapable of meeting application requirements. As a result, if a notebook computer can be equipped with at least one plugin recess in its control panel that enables consumers to install as required an expansion module, such as a multimedia keyboard module, having inputting capability and, furthermore, insert various multimedia interface cards that support multimedia applications, such a desired design would not only broaden consumer convenience to a virtually unlimited extent but also be a significant contribution to information technology as well as an remarkable achievement.

### SUMMARY OF THE INVENTION

Based on the in-depth analysis of the preceding section, we realize that a conventional notebook computer has inadequate expansion capacity and that the current research and development theme of various computer manufacturers includes a constant focus on notebook computers having multimedia capability and, furthermore, ergonomic, all-in-one features among their major research and development objectives. Therefore, to improve the said shortcomings as well as support research and development trends in current information technology, the inventor of the invention herein conducted long-term, extensive research and experimentation that culminated in the successful development and design of the notebook computer plug-in recess structure of the invention herein.

The invention herein is a notebook computer plug-in recess structure consisting of a mainboard installed within the said main system case of a notebook computer, a control panel disposed on the said main system case adjacent to one surface of the screen of the said notebook computer, a minimum of one plug-in recess situated in the said control panel, and a minimum of one connector positioned within the interior section of each said plug-in recess, wherein each said connector is circuited to the said mainboard such that each said expansion module is brought into continuity with the said mainboard via each said connector, enabling the transfer of data from each said expansion module to the said mainboard via the said connector(s) for the subsequent execution of processing or the reception of commands forwarded by the said mainboard.

The above and other objects, features and advantages of the present invention will become apparent from the following detailed description taken with the accompanying drawings.

### BRIEF DESCRIPTION OF THE DRAWINGS

FIG. 1 is an isometric drawing of the invention herein (1).

FIG. 2 is an isometric drawing of the invention herein (2).

FIG. 3 is an isometric drawing of the invention herein (3).

### DETAILED DESCRIPTION OF THE INVENTION

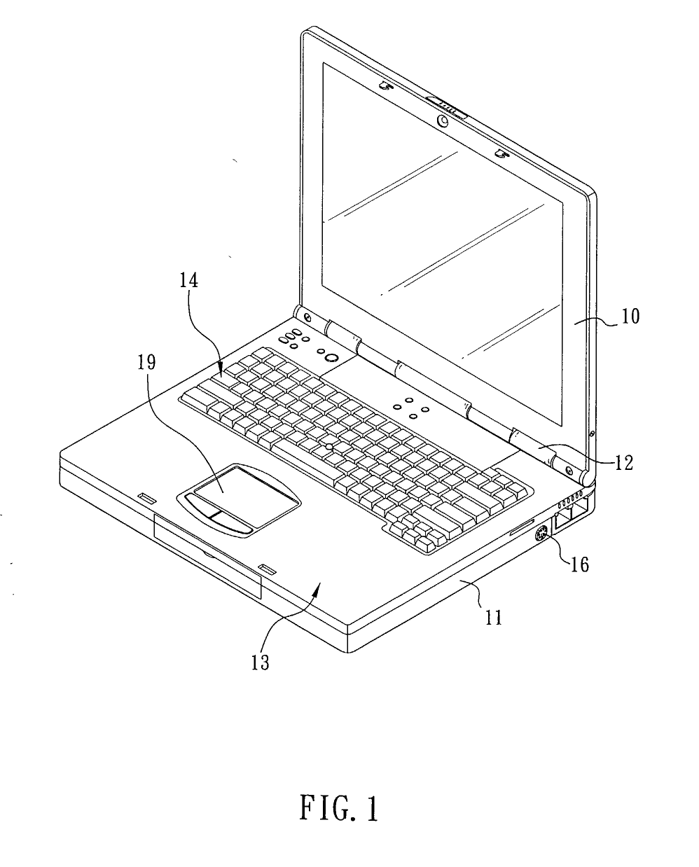

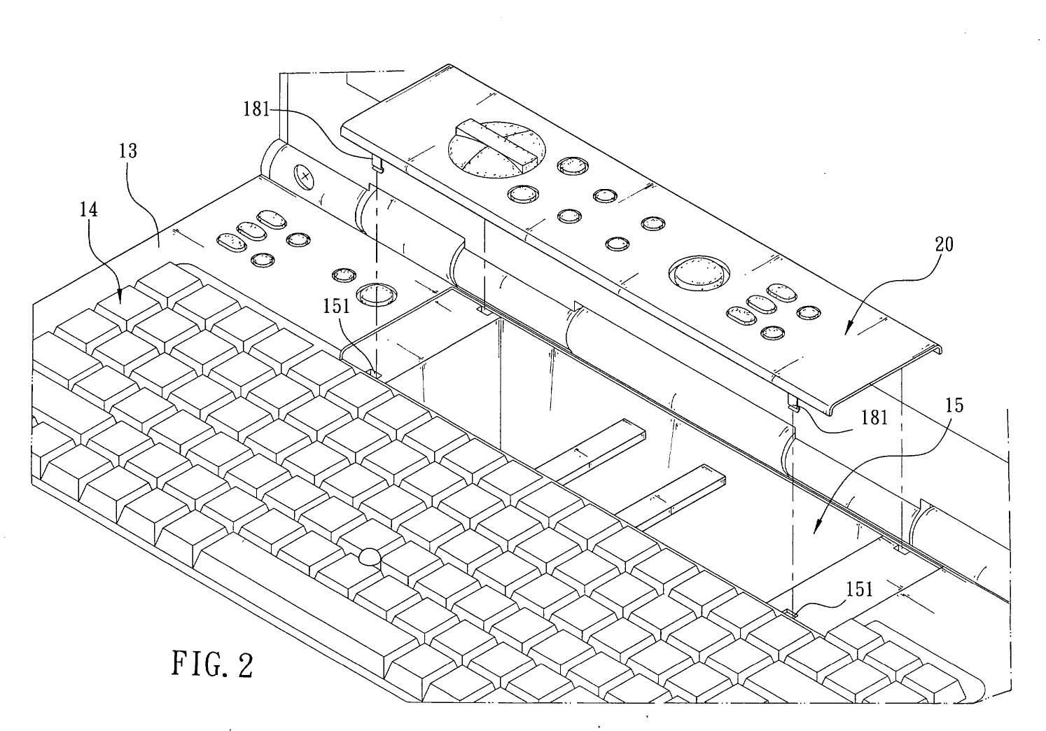

The notebook computer plug-in recess structure of the invention herein, referring to FIG. 1 and FIG. 2, is comprised of a screen 10, a main system case 11, and a minimum of one hinge component 12 installed at one end of the said main system case 11 that conjoins it to the said screen 10, enabling the said screen 10 to be covered over the said main system case 11 and, furthermore, the rotation of said screen 10 on the said hinge component 12 until an appropriate operating position is reached, wherein a mainboard is installed within the said main system case 11, a control panel 13 is disposed on the said main system case 11 adjacent to one surface of the said screen 10, a keyboard module 14 is inset in the surface of the said control panel 13 proximal to one end of the said screen 10, a minimum of one plug-in recess 15 is situated between the said keyboard module 14 and the said screen 10, and a minimum of one connector is positioned within the interior section of each said plug-in recess 15, with each said connector circuited to the said mainboard such that a minimum of one expansion module 20 can be docked onto each said plug-in recess 15 and, furthermore, such that each said expansion module 20 is attached to each said connector, enabling the transfer of data from each said expansion module 20 to the said mainboard via the said connector(s) for the subsequent execution of processing or the reception of commands forwarded by the said mainboard.

In the invention herein, referring to FIG. 1 and FIG. 2, the said expansion module 20 can be a multimedia keyboard having a plurality of key switches, with the data inputted by the said key switches transferred through the said connector(s) to the said mainboard for the execution of processing and utilized to operate multimedia software installed in the said notebook computer, enabling said notebook computer to output various multimedia functions such as opening a multimedia broadcast program to broadcast, temporarily halt, or fast forward video and audio files as well as opening and closing a browser. In addition, the said expansion module 20 can be a pointing device such as a track ball that is utilized to control the movement of a cursor displayed on the said screen 10 and, furthermore, the said expansion module 20 can be a multimedia interface card such as video frequency data transfer card, a video frequency compression card, or an audio frequency compression card.

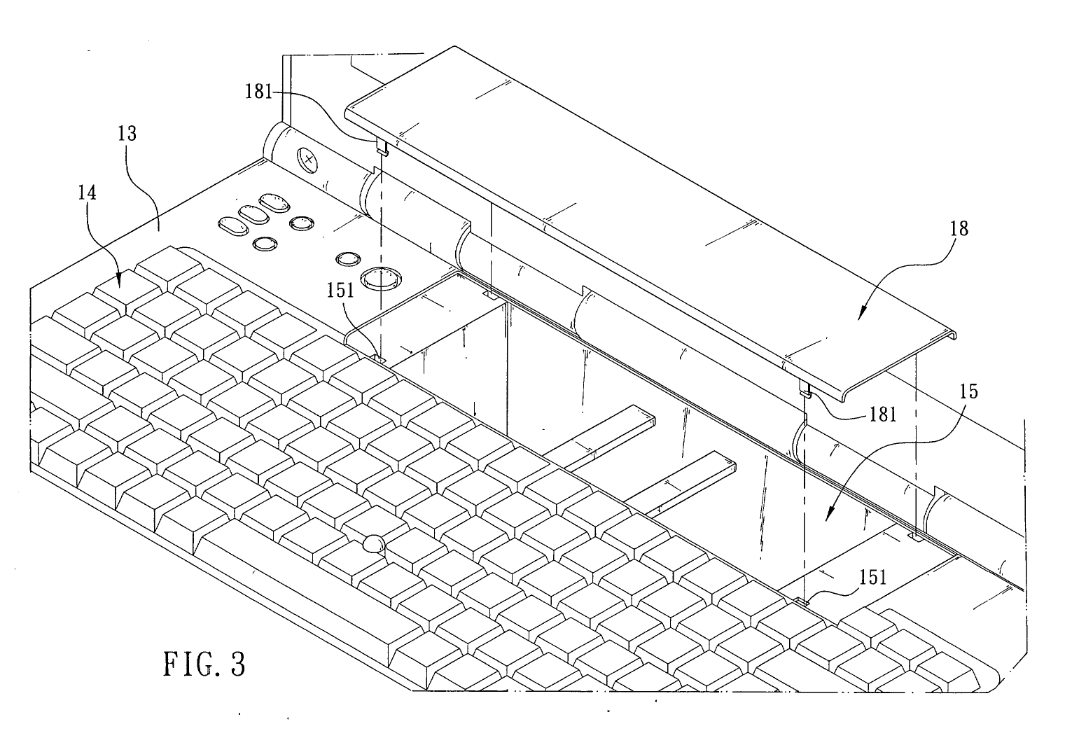

In the invention herein, referring to FIG. 2 and FIG. 3, each said plug-in recess 15 is equipped with a matching lid 18 such that when no expansion module 20 is installed, each said lid 18 serves as cover that protects each said connector.

In the invention herein, referring to FIG. 1, FIG. 2, and FIG. 3, each said expansion module 20 and each said lid 18 has a minimum of one fastening component 181, with another fastening component 151 disposed adjacent to each said plug-in recess 15 in the said control panel 13 in an arrangement matching that of the said fastening component 181 such that when each said expansion module 20 or each said lid 18 is installed in or on the said plug-in recess 15, each said fastening component 181 engages the other said fastening component 151, wherein each said fastening component 181 consists of a projecting hook and each other fastening component 151 consists of an indented engagement slot that enables each said expansion module 20 or each said lid 18 to be securely installed on the said control panel 13.

In the invention herein, referring to FIG. 1, a minimum of one input port 16 circuited to the said mainboard enables the connection of an external input device to the said mainboard via the said input port 16, wherein the said input port 16 can be a Universal Serial Bus (USB) interface and the said input device can be a mouse.

In the invention herein, referring to FIG. 1, the said keyboard module 14 can be a membrane keyboard and a minimum of one pointing device 19 is installed on the said control panel 13; the said pointing device 19 can be an input device that controls the movement of a pointer on the said screen 10 and has the same function as a mouse and, therefore, can be a pointing stick (also known as a track point), a touch pad, or a track ball.

While the invention has been described by means of specific embodiments, numerous modifications and variations could be made thereto by those skilled in the art without departing from the scope and spirit of the invention set forth in the claims.

1. A notebook computer plug-in recess structure comprised of:
a main system case having an internally installed mainboard;
a screen that is pivotably conjoined to one end of the said main system case;
a control panel disposed adjacent to one surface of the said screen on the said main system case and on which is situated:
a keyboard module inset in the said control panel proximal to one end of the said screen;
a minimum of one plug-in recess situated between the said keyboard module and the said screen that provides for the installation of an expansion module;
a minimum of one connector positioned within each said plug-in recess, with each said connector circuited to the said mainboard and, furthermore, attached to the said expansion module installed in each said plug-in recess, thereby enabling the transfer of data from each said expansion module to the said mainboard via the said connector(s) for the subsequent execution of processing.

2. A notebook computer plug-in recess structure as claimed in claim 1 in which the said expansion module can be a multimedia keyboard, the said multimedia keyboard having a plurality of key switches, with the data inputted by the said key switches transferred through the said connector(s) to the said mainboard for the execution of processing and utilized to operate multimedia software installed in the said notebook computer.

3. A notebook computer plug-in recess structure as claimed in claim 1 in which the said expansion module can be a multimedia interface card.

4. A notebook computer plug-in recess structure as claimed in claim 1 in which each said plug-in recess is equipped with a matching lid such that when no expansion module is installed, each said lid serves as cover that protects each said connector.

5. A notebook computer plug-in recess structure as claimed in claim 2 in which each said expansion module has a minimum of one fastening component, with another fastening component disposed adjacent to each said plug-in recess in the said control panel in an arrangement matching that of the said fastening component thereby enabling each said expansion module to be securely installed on the said control panel.

6. A notebook computer plug-in recess structure as claimed in claim 4 in which each said lid has a minimum of one fastening component, with another fastening component disposed adjacent to each said plug-in recess in the said control panel in an arrangement matching that of the said fastening component thereby enabling each said lid to be securely installed on the said control panel.

7. A notebook computer plug-in recess structure as claimed in claim 5 in which each said fastening component consists of a projecting hook and each said other fastening component consists of an indented engagement slot.
